(19) United States
(12) Patent Application Publication
(10) Pub. No.: US 2026/0280407 A1
(43) Pub. Date: Sep. 17, 2026

(54) FLYBACK CONVERTER SYSTEM WITH VARIABLE FREQUENCY AND ASYNCHRONOUS CONTROL

(71) Applicant: Enatel, Christchurch (NZ)

(72) Inventors: David Ruddenklau, Christchurch (NZ); Joseph Cooper, Lyttleton (NZ)

(21) Appl. No.: 19/473,973

(22) PCT Filed: May 9, 2023
(86) PCT No.: PCT/NZ2023/050051

§ 371 Date: Oct. 9, 2025

(51) Int. Cl. H02M 1/00; H02M 1/088; H02M 1/15; H02M 1/44; H02M 3/335

(52) U.S. Cl. CPC H02M 1/0058; H02M 1/0083; H02M 1/088; H02M 1/15; H02M 1/44; H02M 3/33507

(57) ABSTRACT

An electrical converter system includes a first electrical converter having a first switch, a second electrical converter having a second switch, the second converter being in parallel with the first electrical converter, and a controller in electrical communication with the first switch and the second switch and configured to calculate and output a first control signal for the first switch and a second control signal for the second switch, wherein output of the first and second control signals is asynchronous, wherein a frequency of at least one of the first control signal or the second control signal is variable.

### FIELD OF THE DISCLOSURE

The instant disclosure relates to DC/DC converters, including a converter system having multiple DC/DC converters.

### BACKGROUND

A flyback converter is a widely used low power DC-DC switching converter topology. Flybacks are often variable frequency to cover the input, output, and load range efficiently. Flybacks are typically used in applications up to about 300 W and usually have simple controllers with minimal drive circuitry and power switches, and as a result typically do not have good transformer utilization and are not typically sufficiently efficient for use in higher-power applications.

### BRIEF DESCRIPTION OF THE DRAWINGS

FIG. 1 is a schematic and block diagram view of an example flyback converter topology.

FIG. 2 is a plot illustrating an example control strategy for a sequence of converters in a system having multiple electrical converters.

FIG. 3 is a plot illustrating an example control strategy for a sequence of converters in a system having multiple electrical converters.

FIG. 4 is a block diagram illustrating an example system-having multiple electrical converters.

FIG. 5 is a flow chart illustrating an example method of operating a system having multiple electrical converters.

### DETAILED DESCRIPTION

A converter system according to the present disclosure enables use of a flyback converter in a higher-power application, e.g., 1.5 kW, relative to known converter topologies and control strategies. In particular, a novel combination of control strategy and topology enables asynchronous control of a converter system, operating at variable switching frequency, with multiple parallel converters, that can scale its output power to meet a variable demand. Through the use of the novel control strategies of this disclosure (e.g., with a microcontroller or other computing device), more complex waveforms can be generated for control of the flyback to increase the efficiency of the converter system.

An additional benefit of complex control waveforms is that the system can be scaled up through the use of a desired number of converters in parallel to meet a needed output power. A microcontroller enables asynchronous control and interleaving of parallel stages with fixed phase.

Synchronous Control. Typically a digital control loop runs at, or at a submultiple of, the converter switching frequency. This is known as synchronous control. For a variable frequency converter, synchronous control typically has two drawbacks. First, the upper converter switching frequency is limited by the maximum (or submultiple) of the control loop time. Second, filters and control gains often need to be adjusted or compensated depending on the operating point (i.e., frequency) of the control loop.

Asynchronous Control. Alternatively, a digital control loop can be run at a fixed frequency, enabling the switching waveforms to operate independent of the control loop frequency. This is known as asynchronous control. Asynchronous control allows for a wider range of switching frequencies and allows for fixed filters and fixed control gains. Updating of the control waveforms may benefit from the particular strategies of this disclosure when the control loop and switching waveforms are not synchronized.

Parallel Converters with Fixed Phase. Two or more variable frequency converters can be put in parallel, but they will drift in and out of phase unless specifically controlled to remain in phase. Fixed phasing is desirable for several reasons. First, fixed phasing generally results in reduced ripple current, and thus fewer capacitors and/or less filtering is required. Second, fixed phasing can result in a reduced amplitude of harmonics. Specifically, by choosing specific phasing the amplitude of the harmonics can be reduced, thereby reducing noise, EMC, and interference to communication protocols such as power-line carrier. Phasing can be maintained by adjusting the control signal periods of parallel converters slightly to keep the desired phase. This is known as phase locking.

The instant disclosure provides novel strategies for asynchronous control and fixed phasing of variable frequency parallel converters. Elements of this disclosure include, for example, determination of waveforms including: (a) timings to transfer output power to the load; (b) valley timings for improved efficiency; (c) phase relationships between the stages (as frequency changes, the time between cycles may also change to maintain the same phase relationship between stages); and (d) adjustments to remove errors, non-linear effects, and keep stages correctly phased. Such adjustments may be made, for example, when the load on the converter system changes. The waveforms may be updated in the same order each time to maintain the phasing between parallel stages.

As described in detail below, a microcontroller may calculate the timings of the switching waveforms, in some embodiments. The first stage may latch in the waveform values at the beginning of each switching cycle (if the switching frequency is much higher than the control it can latch in the same values again; conversely if the switching frequency is much slower it could miss an update, but this does not matter as the most recent one will be more accurate). After the first stage has updated its values, the first stage's values may be copied, and the frequency adjustment to move the second stage to the required phase is is calculated. The calculated frequency, or change to the frequency, is then copied to the second stage. This process continues for any additional parallel stage(s). More generally, updating the switching waveform characteristics within a multi-converter system may include updating converters in sequence, with each converter (after the first) having its switching waveform determined, in part, based on the switching waveform of the previous converter stage, to maintain a phased relationship between stages.

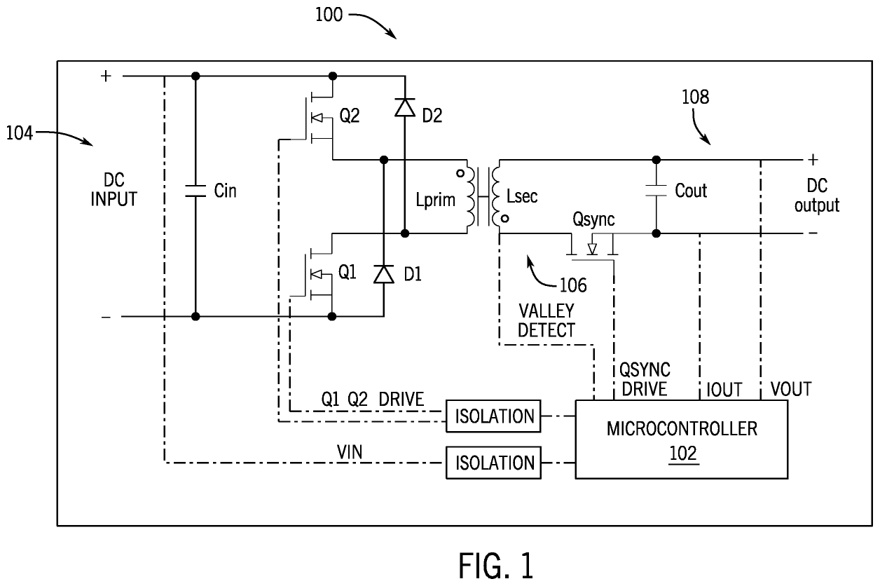

Referring now to the drawings, wherein like numerals refer to the same or similar features in the various views, FIG. 1 is a schematic and block diagram view of an example electrical converter 100. The converter 100 may include, among other components, a first switch Q1, a second switch Q2, and a microcontroller 102 or other electronic controller configured to calculate and output the switching control waveforms for switches Q1, Q2. The microcontroller 102 may be electrically coupled to several nodes within the converter 100, including an input voltage node 104, an inductor output node 106, and a converter output node 108. As a result, the microcontroller receives, as input, the converter input voltage Vin, the converter output voltage Vout, and the converter output current Iout. The microcontroller 102 may have stored values for the inductor primary coil inductance Lprim and the inductor secondary coil inductance Lsec. The microcontroller may additionally determine the transformer turns ratio N (where Lprim/Lsec=N²). The microcontroller 102 may further utilize values including the maximum switching frequency fmax, the minimum switching period Tₘᵢₙ=1/fₘₐₓ, the minimum switching frequency fmin, and the maximum switching period Tₘₐₓ=1/fₘᵢₙ. The maximum switching frequency fmax may be limited by, for example, hardware limitations, emissions/interference reasons, or efficiency improvements. The minimum switching frequency fmin may be limited by, for example, eliminating audible noise, improving transient response, or microprocessor timer/counter resolution. In some embodiments, cycle skipping can be used to avoid going below the minimum frequency.

Though the converter 100 is described herein as including a microcontroller 102, any appropriate controller may be used. For example, a processor executing instructions may be used, or a hardware-based controller, a field-programmable gate array (FPGA), or any appropriate combination of hardware and software.

The basic operation of the converter 100 is as follows. The primary switches, MOSFETs Q1, Q2 turn on, and current builds up in the transformer primary coil Lprim. The primary switches, MOSFETs Q1, Q2 turn off, and the current built in the transformer is delivered from the transformer secondary coil Lsec to the DC output node 108 and returned via the diode in switch Qsync. Diodes D1 and D2 regenerate the energy stored in the leakage of the transformer back into the DC input node 104. In some embodiments, MOSFET Qsync may be turned on during power delivery to output node 108 and then turned off just before the output current has dropped to zero to avoid sending power back the other way, to improve the efficiency of the converter 100. Once the energy from the transformer has been delivered to the load on the DC output node 108, the cycle can start again by switching on primary switch MOSFETs Q1, Q2.

MOSFET Qsync, in some embodiments, includes a body diode that is intrinsic to its construction. In some alternative embodiments, a simple diode may be used instead of MOSFET Qsync to save cost. Such a lower-cost implementation would likely result in lower efficiency of the converter 100.

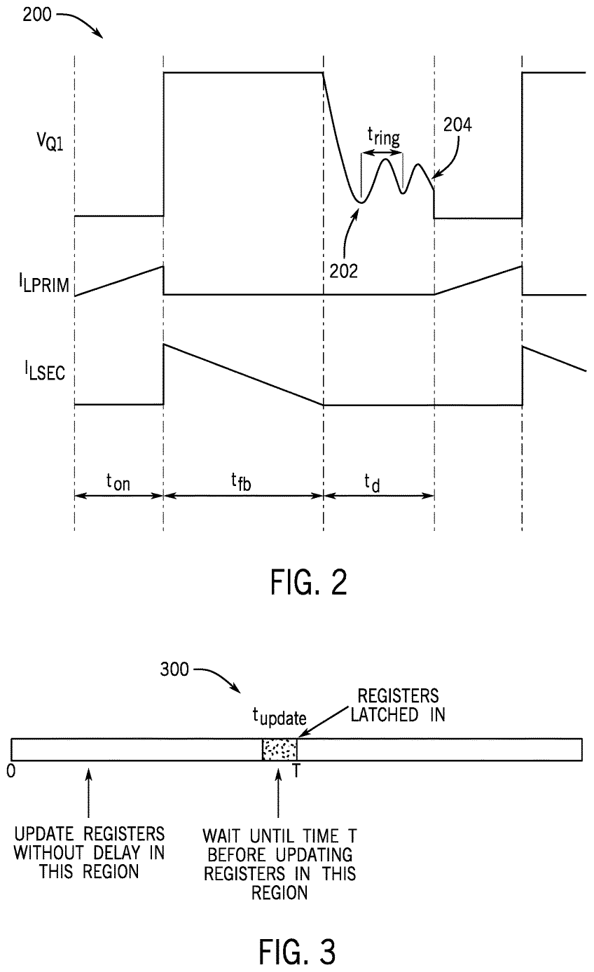

FIG. 2 illustrates current and voltage waveforms for the converter 100, where:
VQ1 is the voltage at MOSFET Q1
tₒₙ is the primary MOSFET (Q1, Q2) on time
t_{fb} is the flyback time (time the primary built up energy is transferred to the output node)
t_{d} is the dead time (delay/idle time)
t_{ring} is the ring time (time from energy used to quasi-resonant point is t_{ring}/2)
T is the total time (period) of switching waveforms (tₒₙ+t_{fb}+t_{d}); f is the frequency of operation (1/T)
t_{on_min} is the minimum primary MOSFET on time (usually due to hardware limitations)
Iₒᵤₜ is the output current and is the average of the L_{sec} current waveform

As annotated in FIG. 2, to improve the efficiency of the converter 100, the start of a new cycle can be delayed by some time to allow for quasi-resonant switching (by delaying to, and switching at, at a first valley 202 in the output current) or any subsequent valley switching (by skipping one or more valleys, then switching at a subsequent valley 204). This reduces the voltage the primary MOSFETs Q1, Q2 turn on at, which reduces the primary turn-on losses. In FIG. 2, valley switching is employed, with the primary switch Q1 being turned off at a third valley 204 in VQ1.

Referring to FIGS. 1 and 2, valleys in VQ1 can be detected by the microcontroller 102 and/or calculated by the microcontroller 102. For example, the “valley detect” signal from inductor output node 106 may be indicative of a valley in VQ1 and may be used by microcontroller 102 to detect such a valley. Additionally or alternatively, microcontroller may calculate valleys in VQ1 according to the timing signals output by the microcontroller 102 in conjunction with known electrical parameters of the components of the converter 100.

The controller 100 may be selectively operated in one of a plurality of modes, with the modes differing from each other by one or more of switching frequency range, flyback time t_{fb}, and dead time t_{d}. Modes of operation include, but are not limited to, quasi-resonant (which may find particular use for high output power), valley skipping (which may find particular use for medium output power), minimum frequency (which may find particular use for low output power), and cycle skipping (which may find particular use for very low/no output power). The valley skipping and minimum frequency modes can be combined, in some embodiments. For example, tₒₙ and the switching frequency may be simultaneously decreased to reach cycle skipping mode at the same point as if valley skipping mode were followed by minimum frequency mode, as discussed herein.

With high output power needed (i.e., with a high load demand, and consequently a high output current), the converter may be commanded to operate in quasi-resonant mode by the microcontroller 102. As the load lightens, the microcontroller increases the switching frequency of switches Q1, Q2. Once the frequency reaches a maximum predetermined frequency, the microcontroller 102 enters valley skipping mode and decreases the switching frequency by skipping out valleys. When the switching frequency reaches a predetermined minimum frequency, the microcontroller 102 enters minimum frequency mode. In this mode, the microcontroller decreases the on time to a minimum predetermined quantity of time. Once the minimum on time is reached, the microcontroller 102 enters cycle skipping mode. Calculations for each of these values are below. Each of the below calculations is derived from

$$V = L \frac{di}{dt}$$

and calculating Iₒᵤₜ from the average of the L_{sec} triangle current waveform as shown in FIG. 2.

First, microcontroller 102 may calculate tₒₙ at the maximum switching frequency according to equation (1) below:

$${t}_{on max boundary} = \frac{( {T}_{min} - {t}_{ring / 2} ) \times N \times {V}_{out}}{N \times {V}_{out} + {V}_{in}} \qquad ( Eq . 1 )$$

where N is the number of turns in the primary transformer coil. Microcontroller 102 may calculate all values disclosed herein.

The maximum frequency boundary current may be calculated according to equation (2) below:

$${I}_{f max boundary} = \frac{{V}_{in}^{2} \times {t}_{on max boundary}^{2}}{2 \times {T}_{min} \times {L}_{sec} \times {N}^{2} \times {V}_{out}} \qquad ( Eq . 2 )$$

The minimum frequency boundary current may be calculated according to equation (3) below, in which the same tₒₙ is used and is fixed, but the period may be changed:

$${I}_{f min boundary} = \frac{{V}_{in}^{2} \times {t}_{on max boundary}^{2}}{2 \times {T}_{max} \times {L}_{sec} \times {N}^{2} \times {V}_{out}} \qquad ( Eq . 3 )$$

Quasi-Resonant Mode. When Iₒᵤₜ≥I_{f max boundary}, the microcontroller 102 may enter quasi-resonant mode (i.e., may command the controller 100 to operate in quasi-resonant mode). In quasi-resonant mode, tₒₙ, t_{d}, T, and f may be calculated according to equations (4)-(8) below:

$${t}_{on} = \frac{N \times {I}_{out} \times {L}_{sec} ( ( N \times {V}_{out} + {V}_{in} ) + \sqrt{{( N \times {V}_{out} + {V}_{in} )}^{2} + \frac{2 \times {V}_{in}^{2} \times {V}_{out} \times \frac{{t}_{ring}}{2}}{{I}_{out} \times {L}_{sec}}} )}{( {V}_{in}^{2} )} \qquad ( Eq . 4 )$$

$${t}_{fb} = \frac{{V}_{in}}{N \times {V}_{out}} {t}_{on} \qquad ( Eq . 5 )$$

$${t}_{d} = \frac{{t}_{ring}}{2} \qquad ( Eq . 6 )$$

$$T = {t}_{on} + {t}_{fb} + {t}_{d} \qquad ( Eq . 7 )$$

$$f = \frac{1}{T} \qquad ( Eq . 8 )$$

Valley Skipping Mode. When Iₒᵤₜ<I_{f max boundary} and Iₒᵤₜ≥I_{f min boundary}, the microcontroller 102 may enter valley skipping mode. In valley skipping mode, tₒₙ, t_{d}, T, and f may be calculated according to equations (9)-(13) below:

$${t}_{on} = {t}_{on max boundary} \qquad ( Eq . 9 )$$

$${t}_{fb} = \frac{{V}_{in}}{N \times {V}_{out}} {t}_{on} \qquad ( Eq . 10 )$$

$${t}_{d} = \frac{{V}_{out} \times {t}_{fb}^{2}}{2 \times {I}_{out} \times {L}_{sec}} - {t}_{on} - {t}_{fb} \qquad ( Eq . 11 )$$

$$T = {t}_{on} + {t}_{fb} + {t}_{d} \qquad ( Eq . 12 )$$

$$f = \frac{1}{T} \qquad ( Eq . 13 )$$

In valley skipping mode, in some embodiments, t_{d} may be a multiple of t_{ring} (plus the initial t_{ring}/2) to improve efficiency. For example t_{d} may be set to the next highest multiple of t_{ring} from its value before valley skipping mode was entered. tₒₙ can then be recalculated using the formula from the quasi-resonant mode (by replacing t_{ring}/2 with the new t_{d}). Finally, t_{fb} can be recalculated.

Minimum Frequency Mode. When Iₒᵤₜ<I_{f min boundary}, the microcontroller 102 may enter minimum frequency mode. In minimum frequency mode, the switching frequency f is predefined to be the minimum frequency, and tₒₙ, t_{d}, T, and f may be calculated according to equations (14)-(18) below:

$$f = {f}_{min} \qquad ( Eq . 14 )$$

$$T = {T}_{max} \qquad ( Eq . 15 )$$

$${t}_{on} = \sqrt{\frac{2 \times {I}_{out} \times {L}_{sec} \times {V}_{out} \times {N}^{2} \times {T}_{max}}{{V}_{in}^{2}}} \qquad ( Eq . 16 )$$

$${t}_{fb} = \frac{{V}_{in}}{N \times {V}_{out}} {t}_{on} \qquad ( Eq . 17 )$$

$${t}_{d} = {T}_{max} - {t}_{on} - {t}_{fb} \qquad ( Eq . 18 )$$

Cycle Skipping Mode. In cycle skipping mode, if tₒₙ<t_{on_min}, then the microcontroller 102 may skip pulses to reduce output ripple. The microcontroller 102 may calculate the number of cycles to skip based on the energy stored in inductor as 0.5×L×I². Since the inductance is fixed, the number of cycles is a square relationship. For example, if tₒₙ is half of t_{on_min} then t_{on_min} may be output every 0.5²=0.25 (i.e—put the minimum pulse out every 4^{th} cycle).

In some embodiments, adjustments may be made to the calculations above to reduce errors and non-linear effects. For example, a PI (Proportional Integral) controller on the Iₒᵤₜ variable may be added to one or more calculations. An outer voltage control then may control voltage when it is not current limited.

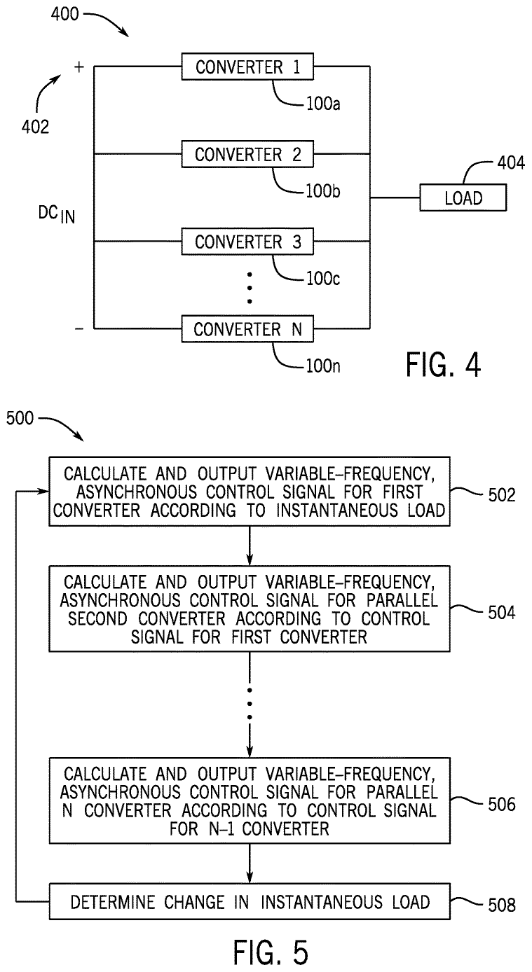

The microcontroller 102 may also account for multiple parallel converters 100 in its switch control signal generation and output. For example, referring to FIG. 4, an electrical converter system 400 may include a plurality of electrical converters 100a, 100b, 100c, . . . 100n electrically coupled in parallel between a DC power input source 402 and a load 404. The load may be, for example, one or more batteries to be charged. At certain sites, a large number of batteries may be used, for example, as a source of power for motive power equipment, including electric vehicles (EVs) such as forklifts. Such sites may include warehouses, department stores, manufacturing facilities, or any other sites where materials are handled. While forklifts are merely one use of batteries, batteries may be used for other types of EVs and/or may be used for other purposes than EVs. Batteries at such a site may be charged using battery chargers, so that the batteries may be reusable. Accordingly, the electrical converter system 400 may find use as a charger for one or more batteries, and the load changes described herein may result from the coupling or decoupling of a battery to be charged, and/or the completion of charging of a battery.

When a single converter 100 is used, the calculations for determining the aspects of a switching signal may be calculated as discussed above. When multiple converters 100 may used in parallel, calculations and updates may be performed as described below.

When multiple converters 100 are provided in a converter system 400, the multiple converters 100 may share a common microcontroller 102, in some embodiments. Alternatively, each converter 100 may have its own microcontroller 102, and the multiple microcontrollers may communicate with one another to implement the functionality herein. In yet another alternative, subsets of the multiple converters 100 may share common microcontrollers, such that the number of microcontrollers is more than one but fewer than the number of converter stages. Accordingly, though the discussion herein is with respect to a single microcontroller 102, it should be understood that such calculations may be performed by more than one microcontroller 102, or shared among microcontrollers 102, in some embodiments.

To account for parallel converters 100 (which may be referred to herein as converter stages), for the calculations of this disclosure the microcontroller 102 may divide the current for each stage by the number of stages in parallel so the same computing code and calculations can be used as would be used for a single-stage implementation. For example, if 50A is required at the output and the system 400 includes two stages, 25A is used in the calculations above.

FIG. 5 is a flow chart illustrating an example method 500 of operating an electrical converter system. The method 500, or one or more aspects of the 300, may be performed by the microcontroller 102, or by two or more microcontrollers 102 in conjunction in a system.

In the method 500, the microcontroller 102 may generate and output control signals for switches of multiple converters to, in part, operate the multiple controllers in a common mode and control phasing between parallel converter stages, which is not generally performed in multi-stage converters, but assists with performance of a converter system in which the control loop is asynchronous with the switching waveforms. To maintain phasing, updates to switching waveforms—that is, changes to the frequency, period, or delay of the waveform—may be synchronous to the switching frequency. In addition, standard double buffering techniques cannot be used, as more than one register (microcontroller location that implements the waveform timings) need to be written to as (1) duty cycle and (2) period are updated. At the start of a new cycle, the timing information is latched in. This works fine if all registers have been updated, but if only some have been updated, the waveforms will be wrong, as they will be a combination of the old and new waveforms. An example synchronization technique that may be implemented by the microcontroller 102 is descried in detail below.

The method 500 may include, at block 502, calculating and outputting a control signal for the first converter according to the instantaneous load on the system. For example, the microcontroller may determine a frequency f, switch on time tₒₙ, and dead time t_{d} according to equations (1)-(18) above (e.g., by selecting a mode of operation and then calculating the switching signal aspects according to the appropriate set of equations for that mode). Block 502 may include accounting for other controllers when determining when to output an update based on a detected change in the load. The microcontroller 102 knows how much time it takes to update all the registers for all of the controllers, t_{update}. The microcontroller 102 compares where the switching waveform is in its cycle relative to when the waveform updates are done, T. If data is going to be latched in before an update can be completed, the microcontroller may wait until it has latched the registers in and then update, otherwise update.

FIG. 3 is a timing diagram illustrating the above-described relationship between T, t_{update}, and the decision made by the microcontroller 102 about when to command a switching signal update. As shown, if the present time in the switching cycle is less than T−t_{update}, the update may be commanded. If the present time in the switching cycle is equal to or greater than T−t_{update}, the update may be held by the microcontroller 102 and commanded after T. The following pseudo code also shows this process:

```
t is the current time
if (T−t) ≤ t_{update}{
  wait (T−t)
  update waveforms
}
else {
  update wavefroms
}
```

The control signal for the first converter may be variable-frequency (i.e., the frequency of the control signal may be adjusted overtime), and may be calculated asynchronously with respect to the control signal itself. Similarly, additional switching signals disclosed below may be variable-frequency, and may be calculated and output asynchronously with respect to the switching signal itself.

The method 500 may further include, at block 504, calculating and outputting a control signal for the second converter. The controller 102 of the first stage may generate and output an interrupt (timing signal) to the subsequent stage that is synchronous to the switching waveform of the first stage. Generating and outputting the timing signal may include copying out the latched-in information from the first stage (which ensures that the subsequent stages get the same waveforms), determining if the registers were updated in the last cycle (a flag is set high when the values are latched into this stage and is cleared when new values are written ready to be latched), and, if new waveforms were latched in the last cycle, adjusting the frequency of the waveform to achieve phasing, suspending updates, writing to registers, then enabling updates and clearing the update flag. If an update was not latched in the last cycle, no update is performed.

The above-described update process avoids multiple consecutive cycles with missed updates. For example, there is a chance each time this code is run the switching waveforms could try to latch in right when the updates are suspended. This implementation ensures a maximum of 1 cycle of missed updates.

This process can be represented by the following pseudo code:

```
synchronous switching waveform 1 interrupt {
  copy out first stage registers
  measure phase of stage 2 relative to stage 1
  if(phase of stage 2 > phase aim) {
    decrease copied period time and/or valley blanking time
  }
  else {
    increase copied period time and/or valley blanking time
  }
  if(update done flag set) {
    suspend updates
    update second stage registers with those copied from stage 1 and
    adjusted
    resume updates
    clear update done flag
  }
}
```

The control signal for the second converter may be variable-frequency (i.e., the frequency of the control signal may be adjusted over time) and may be calculated asynchronously with respect to the control signal itself.

The method 500 may further include, at block 506, calculating and outputting a control signal for each remaining parallel converter N according to the control signal for the N−1 converter. That is, each stage after the second stage can be updated in the same manner as the second stage was updated, with each stage generating and outputting an interrupt (timing signal) to the subsequent stage that is synchronous to the switching waveform of the stage.

The method 500 may further include, at block 508, determining a change in the instantaneous load. In response to determining a change in the instantaneous load, the method may return to block 502. In some embodiments, the microcontroller 102 may persistently monitor an output current (e.g., sampling the output current on a regular basis) to determine when an instantaneous load change has occurred.

In a first aspect of the present disclosure, an electrical converter system is provided that includes a first electrical converter having a first switch, a second electrical converter having a second switch, the second converter being in parallel with the first electrical converter, and a controller in electrical communication with the first switch and the second switch. The controller is configured to calculate and output a first control signal for the first switch and a second control signal for the second switch, wherein output of the first and second control signals is asynchronous, wherein a frequency of at least one of the first control signal or the second control signal is variable.

In an embodiment of the first aspect, the first and second electrical converters comprise flyback converters.

In an embodiment of the first aspect, the controller is configured to adjust the frequency according to an instantaneous load on the electrical converter system. In a further embodiment of the first aspect, the controller is configured to increase the frequency as the instantaneous load decreases and to decrease the frequency as the instantaneous load increases.

In an embodiment of the first aspect, the controller is configured to calculate and output the second control signal in order to maintain a phase relationship between the first electrical converter and the second converter, wherein the controller is configured to calculate and output the second control signal according to the first control signal and the frequency.

In an embodiment of the first aspect, the controller is configured to adjust a delay in the first control signal or the second control signal according to an instantaneous load on the electrical converter system.

In an embodiment of the first aspect, the controller is configured to perform one or more of receiving a first output signal from the first electrical converter and adjusting a delay in the first control signal according to a valley timing of the first output signal, or receiving a second output signal from the second electrical converter and adjusting a delay in the second control signal according to a valley timing of the second output signal.

In a second aspect of the present disclosure, a method for controlling an electrical converter system is provided. The method includes calculating and outputting a first variable-frequency control signal for a first switch of a first electrical converter, and calculating and outputting a second variable-frequency control signal for a second switch of a second electrical converter that is in parallel with the first electrical converter, wherein output of the first and second control signals is asynchronous.

In an embodiment of the second aspect, the first and second electrical converters comprise flyback converters.

In an embodiment of the second aspect, the method further includes adjusting the frequency according to an instantaneous load on an electrical converter system that includes the first electrical converter and the second electrical converter. In a further embodiment of the second aspect, the method further includes increasing the frequency as the instantaneous load decreases and decreasing the frequency as the instantaneous load increases.

In an embodiment of the second aspect, calculating and outputting the second control signal is in order to maintain a phase relationship between the first electrical converter and the second converter, wherein calculating and outputting the second control signal is according to the first control signal and the frequency.

In an embodiment of the second aspect, the method further includes adjusting a delay in the first control signal or the second control signal according to an instantaneous load on an electrical converter system comprising the first electrical converter and the second electrical converter.

In an embodiment of the second aspect, the method further includes one or more of receiving a first output signal from the first electrical converter and adjusting a delay in the first control signal according to a valley timing of the first output signal, or receiving a second output signal from the second electrical converter and adjusting a delay in the second control signal according to a valley timing of the second output signal.

In a third aspect of the present disclosure, an electrical converter system is provided that includes a plurality of electrical converters, electrically coupled in parallel with one another between an input voltage source and a load, each converter having a respective switch, and a controller in electrical communication with each of the electrical converters. The controller is configured to calculate and output a respective control signal for each switch, wherein a frequency of each control signal is calculated according to the load, a timing of at least one control signal is calculated according to a timing of at least one of the other control signals, and output of the control signals is asynchronous.

In an embodiment of the third aspect, the plurality of electrical converters includes a first electrical converter and one or more second electrical converters, wherein the plurality of electrical converters is ordered in a sequence, and the controller is configured to calculate the timing of the respective control signal for the switch of each second electrical converter according to the control signal of the previous electrical converter in the sequence. In a further embodiment of the third aspect, calculating the timing of a respective control signal according to the control signal of the previous electrical converter in the sequence comprises detecting a valley in an output of the previous electrical converter and, in response to the detected valley, switching the respective control signal.

In an embodiment of the third aspect, each of the electrical converters is identical to each of the other electrical converters.

In an embodiment of the third aspect, each of the electrical converters is a flyback converter.

In an embodiment of the third aspect, the load is a battery.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

We claim:

1. An electrical converter system comprising:
a first electrical converter having a first switch;
a second electrical converter having a second switch, the second converter being in parallel with the first electrical converter; and
a controller in electrical communication with the first switch and the second switch and configured to:
calculate and output a first control signal for the first switch and a second control signal for the second switch, wherein output of the first and second control signals is asynchronous;
wherein a frequency of at least one of the first control signal or the second control signal is variable.

2. The electrical converter system of claim 1, wherein the first and second electrical converters comprise flyback converters.

3. The electrical converter system of claim 1, wherein the controller is configured to adjust the frequency according to an instantaneous load on the electrical converter system.

4. The electrical converter system of claim 3, wherein the controller is configured to increase the frequency as the instantaneous load decreases and to decrease the frequency as the instantaneous load increases.

5. The electrical converter system of claim 1, wherein the controller is configured to calculate and output the second control signal in order to maintain a phase relationship between the first electrical converter and the second converter, wherein the controller is configured to calculate and output the second control signal according to:
the first control signal; and
the frequency.

6. The electrical converter system of claim 1, wherein the controller is configured to adjust a delay in the first control signal or the second control signal according to an instantaneous load on the electrical converter system.

7. The electrical converter system of claim 1, wherein the controller is configured to perform one or more of:
receive a first output signal from the first electrical converter and adjust a delay in the first control signal according to a valley timing of the first output signal; or
receive a second output signal from the second electrical converter and adjust a delay in the second control signal according to a valley timing of the second output signal.

8. A method for controlling an electrical converter system, the method comprising:
calculating and outputting a first variable-frequency control signal for a first switch of a first electrical converter; and
calculating and outputting a second variable-frequency control signal for a second switch of a second electrical converter that is in parallel with the first electrical converter;
wherein output of the first and second control signals is asynchronous.

9. The method of claim 8, wherein the first and second electrical converters comprise flyback converters.

10. The method of claim 8, further comprising adjusting the frequency according to an instantaneous load on an electrical converter system comprising the first electrical converter and the second electrical converter.

11. The method of claim 10, further comprising increasing the frequency as the instantaneous load decreases and decreasing the frequency as the instantaneous load increases.

12. The method of claim 8, wherein calculating and outputting the second control signal is in order to maintain a phase relationship between the first electrical converter and the second converter, wherein calculating and outputting the second control signal is according to:
the first control signal; and
the frequency.

13. The method of claim 8, further comprising adjusting a delay in the first control signal or the second control signal according to an instantaneous load on an electrical converter system comprising the first electrical converter and the second electrical converter.

14. The method of claim 8, further comprising one or more of:
receiving a first output signal from the first electrical converter and adjusting a delay in the first control signal according to a valley timing of the first output signal; or
receiving a second output signal from the second electrical converter and adjusting a delay in the second control signal according to a valley timing of the second output signal.

15. An electrical converter system comprising:
a plurality of electrical converters, electrically coupled in parallel with one another between an input voltage source and a load, each converter having a respective switch; and
a controller in electrical communication with each of the electrical converters and configured to:
calculate and output a respective control signal for each switch, wherein:
a frequency of each control signal is calculated according to the load;
a timing of at least one control signal is calculated according to a timing of at least one of the other control signals; and
output of the control signals is asynchronous.

16. The electrical converter system of claim 15, wherein:
the plurality of electrical converters comprises a first electrical converter and one or more second electrical converters, wherein the plurality of electrical converters is ordered in a sequence; and
the controller is configured to calculate the timing of the respective control signal for the switch of each second electrical converter according to the control signal of the previous electrical converter in the sequence.

17. The electrical converter system of claim 16, wherein calculating the timing of a respective control signal according to the control signal of the previous electrical converter in the sequence comprises detecting a valley in an output of the previous electrical converter and, in response to the detected valley, switching the respective control signal.

18. The electrical converter system of claim 15, wherein each of the electrical converters is identical to each of the other electrical converters.

19. The electrical converter system of claim 15, wherein each of the electrical converters is a flyback converter.

20. The electrical converter system of claim 15, wherein the load is a battery.
